(19) United States
(12) Patent Application Publication
(10) Pub. No.: US 2016/0241074 A1
(43) Pub. Date: Aug. 18, 2016

(54) PORTABLE APPARATUS HAVING DETACHABLE WIRELESS ELEMENTS

(71) Applicant: KUEI-CHANG HSU, Pingzhen City (TW)

(72) Inventor: KUEI-CHANG HSU, Pingzhen City (TW)

(21) Appl. No.: 14/670,404

(22) Filed: Mar. 26, 2015

(30) Foreign Application Priority Data
Feb. 12, 2015 (TW) 104104710

(51) Int. Cl. H02J 7/02

(52) U.S. Cl. CPC H02J 7/025

(57) ABSTRACT

The present invention relates to a portable apparatus having detachable wireless elements. The portable apparatus having detachable wireless elements comprises a first device and a second device, in which the first device is able to charge the second device, access wireless network, and cooperate with the second device to authenticate a user with acoustic patterns or fingerprints. The present invention may improve the convenience and security of operating detachable elements.

### TECHNICAL FIELD

At least one embodiment of the present invention provides a portable apparatus having detachable wireless elements. More particularly, at least one embodiment of the present invention provides a portable apparatus providing the ability to recharge, authenticate, and communicate wirelessly.

### DESCRIPTION OF THE RELATED ART

Mobile apparatuses such as smartphones and tablets are more popular and more available in recent years. Telephone calls and video conferences thus become more convenient. A significant portion of people with high demand of phone calls usually use accessories, such as Bluetooth headsets, with smartphones and tablets to accept incoming calls.

However, the accessories are required to be paired with mobile apparatuses to initiate wireless communications and accept the incoming calls. More particularly, the accessories require PIN numbers to connect the mobile apparatuses. And each time to use the accessories, the accessories have to be manually switched on to connect to the wireless communication. Those steps to turn on, authenticate, and pair are complicated and less instinctive, thus impeding the convenience of using the accessories to have phone calls.

Moreover, the embedded battery in accessories usually is rapidly depleted to empty. It usually requires a charger or cable specific to the accessories on hand and available sockets to recharge the accessories, which is inconvenient to the user.

One foreseeable problem in conventional accessories is that if the accessories are running out of power during phone calls, the calls will be forced to end. Users usually have to manually transfer the call back to mobile apparatuses to continue the calls.

Accordingly, there's a need for a mobile apparatus to mitigate the aforementioned inconvenience.

### SUMMARY

At least one embodiment of the present invention provides a portable apparatus having detachable wireless elements to mitigate the problems in the conventional portable apparatuses. The portable apparatus having detachable wireless elements contains structural designs which are to improve the aforementioned defects.

Some embodiments of the present invention comprise a first device and a second device. The first device further comprises a first connector, a plurality of first rechargeable batteries, a charger, a first microprocessor, a first wireless transceiver, and a first battery management system.

More particularly, the first connector comprises a first power module and a first information exchanger. And the plurality of first rechargeable batteries comprises a first anode and a second cathode. The charger, on the other hand, comprises a second anode and a second cathode, in which the first cathode is electrically connected to the second cathode and the first anode and the second anode are electrically connected to the first power module respectively.

Moreover, the first microprocessor is connected to the first information exchanger and the first wireless transceiver respectively. And the first battery management system is connected to the first microprocessor and the plurality of first rechargeable batteries respectively.

Similarly, the second device comprises a second connector, a plurality of second rechargeable batteries, a second microprocessor, a second battery management system, and a second wireless transceiver.

The second connector, further comprising a second power module and a second information exchanger, is configured to engage with the first connector. The engagement between the first connector and the second connector provides a linkage between the first device and the second device. More particularly, the second power module is electrically connected with the first power module, and the second information exchanger is connected with the first information exchanger.

The second microprocessor, connected with the second information exchanger, is configured in the second device. And the plurality of second rechargeable batteries is connected to the second power module.

Furthermore, the second battery management system is connected to the second microprocessor and the plurality of second rechargeable batteries respectively.

The second wireless transceiver is also connecting with the second microprocessor, in which the second the wireless transceiver is configured to communicate with the first wireless transceiver.

### BRIEF DESCRIPTION OF THE DRAWINGS

FIG. 1 is a schematic diagram illustrating a portable apparatus having detachable wireless elements, according to some embodiments of the present invention.

FIG. 2 is a schematic diagram illustrating a portable apparatus having detachable wireless elements, according to some other embodiments of the present invention.

### DESCRIPTION OF THE PREFERRED EMBODIMENTS

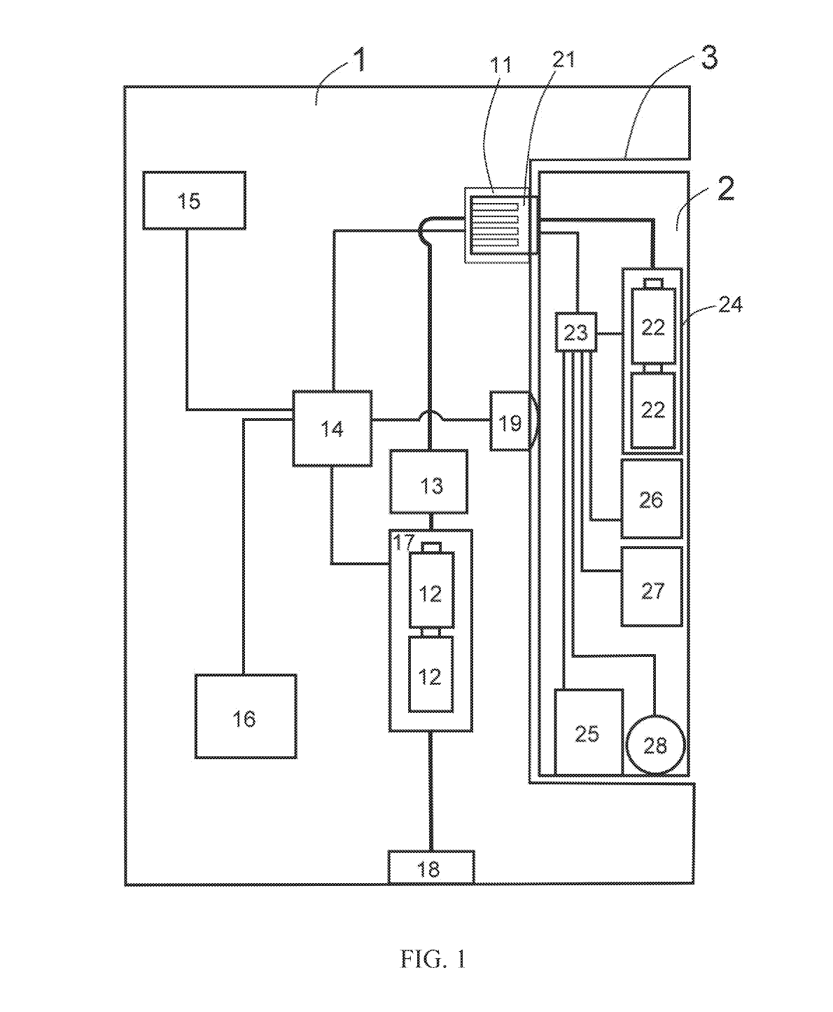

FIG. 1 is a schematic diagram illustrating a portable apparatus having detachable wireless elements, according to some embodiments of the present invention. As shown in FIG. 1, the portable apparatus having detachable wireless elements comprises a first device 1 and a second device 2. The first device 1 may be a tablet, a smartphone, or a personal digital assistant (PDA), in which first device 1 is accessible by a mobile telecommunications network or internet. And the second device 2 may be a wireless headset, in which the second device 2 is accessible by a wireless network. The aforementioned wireless network may be a Bluetooth network, a WiFi network, or an infrared network.

The second device 2 is accommodated in a dock 3 of the first device 1 under some situations, such as when the second device 2 is not in use. To accommodate the second device 2 in the dock 3, the second device 2 is mounted to first device 1 by combining a second connector 21 on the second device 2 with the first connector 11 on the first device 1.

In the embodiments of FIG. 1, the first connector 11 is a female connector while the second connector 21 is a male connector. However, this configuration may be varied based on demands. For example, the first connector 11 may be a male connector or a female connector while the second connector 21 is a male connector or a female connector to be paired with the first connector 11.

Further details inside the first device 1 will be disclosed below. The first device 1 comprises a first connector 11, two first rechargeable batteries 12, a charger 13, a first microprocessor 14, a first wireless transceiver 15, an acoustic pattern recorder 16, a first battery management system 17, a charging port 18, and a pressure sensor 19.

More particularly, the first microprocessor 14 is connecting with the first connector 11, the first wireless transceiver 15, the acoustic pattern recorder 16, the first battery management system 17, and the pressure sensor 19 respectively. The two first rechargeable batteries 12 and the charger 13, on the other hand, are connected to the first connector 11 and the first battery management system 17 respectively. And the charging port 18 is connecting with the first battery management system 17.

Further details inside the second device 2 will be disclosed below. The second device 2 comprises a second connector 21, two second rechargeable batteries 22, a second microprocessor 23, a second battery management system 24, an acoustic pattern recognition module 25, a second wireless transceiver 26, a memory module 27, and an imaging sensor 28.

More particularly, the second connector 21, the second battery management system 24, the acoustic pattern recognition module 25, the second wireless transceiver 26, the memory module 27, and the imaging sensor 28 are connecting with the second microprocessor 23 respectively. And the two second rechargeable batteries 22 are connecting with the second battery management system 24 while the second connector 21 is also connecting with the second battery management system 24.

Moreover, the first connector 11, further comprising a first power module and a first information exchanger, is configured to engage with the second connector having a second power module and a second information exchanger. The physical connection between the first device 1 and the second device 2 provides channels to exchange information, such as battery levels, voice, and data. When the first connector 11 is connected to the second connector 21, the first power module is also connected to the second power module, and the first information exchanger is connected to the second information exchanger.

The first microprocessor 14 and the second microprocessor 23 each is the main processing unit of the first device 1 and the second device 2 respectively. The first microprocessor 14 and the second microprocessor 23 each may be a microcontroller unit (MCU) controlling the operations in the first device 1 and the second device 2 respectively.

In the embodiments, the two first rechargeable batteries 12 are connected in series. Similar to the two first rechargeable batteries 12, the two second rechargeable batteries 22 are also connected in series. The first rechargeable battery 12 and the second rechargeable battery 22 each is made of one selected from the group consisting of lithium iron phosphate, lithium ion, and lithium polymer.

In the first device, the two first rechargeable batteries 12 comprise a first anode and a first cathode, while the charger comprises a second anode and a second cathode. The second cathode is connected to the first cathode. And the first anode and the second anode are electrically connected to the power module in the first connector 11 respectively, in which the connection provides a route to transmit power from the first rechargeable batteries 12 to the second device 2.

The first rechargeable battery 12 is configured in the first battery management system 17, in which the first battery management system 17 is to manage the recharge-discharge process and to be as a battery protection board. In the embodiments, commands from first battery management system 17 are delivered via the first microprocessor 14. The first battery management system 17 is connected to the charging port 18, in which the charging port 18 is configured to receive power from an electric power system and transfer the power to the first rechargeable battery 12. The charger 13, on the other hand, is also connected with the first battery management system 17 and the power module in the first connector 11 respectively. The first device 1 is thus able to power the two second rechargeable batteries 22 in the second device 2 with the charger 13 and the stored power.

Under some situations, such as when the second device 2 is not in use, the first connector 11 may be combined with the second connector 21. While the first connector 11 and the second connector 21 are connected together, the first power module and the second power module recharge the second rechargeable battery 22. And if the battery level of the second rechargeable battery 22 is below 75%, the second battery 22 is recharged with trickle charging. In contrast, when the battery level of the second battery 22 is lower than 25%, the second battery 22 is charged with higher electric current for fast charging.

In some embodiments, the charging process induces the second microprocessor 23 to inactivate the second device 2. More particularly, the charging process is coordinated by the first information exchanger and the second information exchanger to determine the charging conditions, such as to determine the use of trickle charging or fast charging.

And if the physical connection between the first connector 11 and the second connector 21 is broken, the communication between the first information exchanger and the second information exchanger is thus disrupted, and this will automatically turn on wireless connection.

The wireless connection is made between the first wireless transceiver 15 and the second wireless transceiver 26. The first device 1 and the second device 2 are also able to be physically connected together. The first device 1 and the second device 2 do not require the pairing steps each time the wireless connection is turned on if the second device 2 has once physically and wirelessly paired to the first device 1.

The first wireless transceiver and the second wireless transceiver each is a Near Field Communication (NFC) transceiver, a WiFi transceiver, a Bluetooth transceiver, a 4G-LTE transceiver, or a Radio Frequency IDentification (RFID) transceiver.

In some embodiments, the device further comprises a pressure sensor 19. The pressure sensor 19 is connected to the first microprocessor 14 and is configured to detect the engagement between the second device 2 and the dock 3. The pressure sensor 19 may be replaced by a NFC chips to detect the engagement in some other embodiments.

In some embodiments, a user may detach the second device 2 from the first device 1 to accept an incoming call transmitted via a mobile telecommunications network or internet. Upon that the second device 2 is detached from the first device 1, the connection between the first information exchanger and the second information exchanger is disrupted and thus turns on wireless connection. In some other embodiments, the reduced pressure to the pressure sensor 19 may also turns on the wireless connection. The acoustic pattern recorder 16 here is to transfer a registered acoustic data to the acoustic pattern recognition module 25 through the connection between the first wireless transceiver 15 and the second wireless transceiver 26, in which the registered acoustic data may be an acoustic pattern or a password specific to a user. The connection is also used to pass the incoming call to the second device 2.

The acoustic pattern recognition module 25 in the second device 2 is to compare the user's voice and the registered acoustic data. If the user's voice matched the registered acoustic data, the second device 2 accepts the incoming call and thus allows the user to communicate under authenticated condition.

In contrast, if the user's voice failed to match with the registered acoustic pattern or the acoustic pattern recognition module 25 is not in used for a period of time, the acoustic pattern recognition module 25 may leave a record of failure or idle. The record, no matter is based on failure or idle, is then transmitted to the first wireless transceiver 15 via the second wireless transceiver 26 to notify the first device 1 that the user and the registered data are unmatched. The first device 1 may also deny accepting the incoming call based on the record.

In some embodiments, a call will be transferred back to the first device 1 if the battery level of the second device 2 is lower than 5% during a call, to ensure that the call will not be forced to stop. The switching process is coordinated by the second wireless transceiver 26 and the first wireless transceiver 15. And a warning that the battery level of the second device 2 is nearly depleted to empty will be shown on the first device 1. The user may then continue the call on the first device 1. And the second device 2 may be rejoined to the first device 1 to be recharged.

In some embodiments, the second device 2 further comprises a memory module 27 and that the second connector 21 is a male connector. The memory module 27 here may be any memory module known to the art. Under these embodiments, the second connector 21 may be used as a USB stick.

In some embodiments, the second device 2 further comprises an imaging sensor 28 to capture images. The captured images are stored in the memory module 27 and then transferred to the first device 1 through the engagement between the first connector 11 and the second connector 21 or the aforementioned wireless connection.

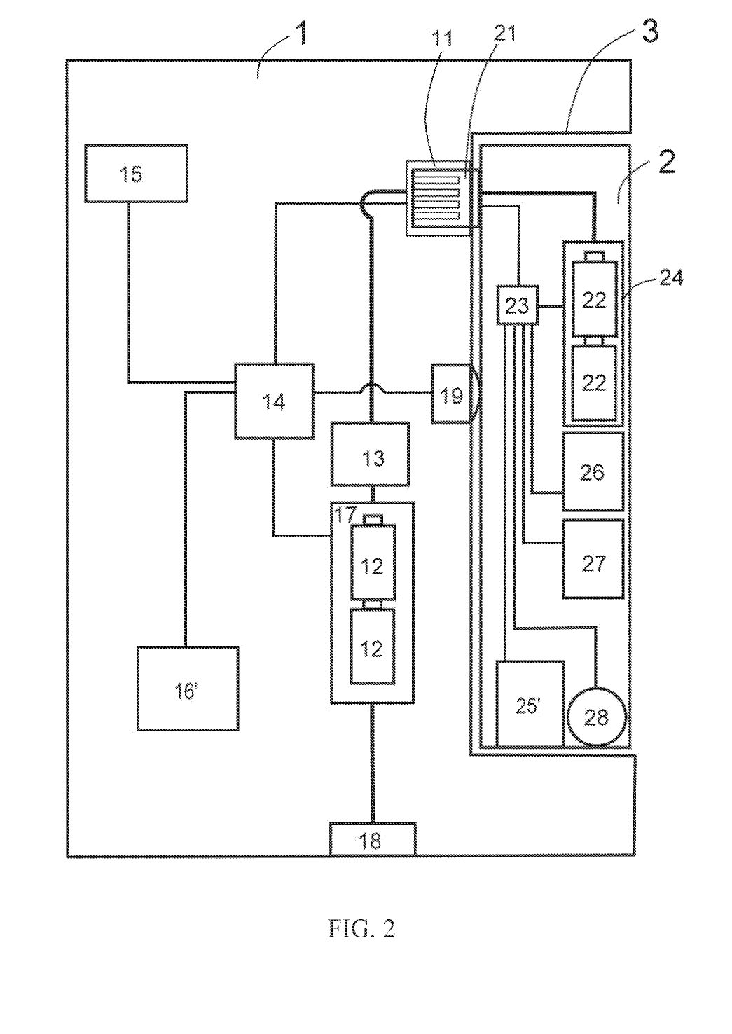

FIG. 2 is a schematic diagram illustrating a portable apparatus having detachable wireless elements, according to some other embodiments of the present invention. As shown in FIG. 2, part of the difference between the embodiments of FIG. 1 and FIG. 2 is that a fingerprint recorder 16′ and a fingerprint recognition module 25′ are used in FIG. 2. The fingerprint recorder 16′ here is to transfer a registered fingerprint, specific to a user, to the fingerprint recognition module 25′ through the connection between the first wireless transceiver 15 and the second wireless transceiver 26. The connection is also used to pass the incoming call to the second device 2. To accept an incoming call, the user may touch the fingerprint recognition module 25′, based on either capacitive fingerprinting or optical fingerprinting, on the second device 2 for authentication.

Some embodiments of the present invention provide an advantage that an incoming call may be easily accepted by detaching the second device 2 from the first device 1. Furthermore, some embodiments provide a secured mechanism to operate detachable elements.

There are many inventions described and illustrated above. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed separately herein.

What is claimed is:

1. A portable apparatus having detachable wireless elements, comprising:
a first device comprising a first connector, wherein the first connector further comprises:
a first power module; and
a first information exchanger;
a plurality of first rechargeable batteries, wherein the plurality of first rechargeable batteries comprises a first anode and a second cathode;
a charger comprising a second anode and a second cathode, wherein the first cathode is electrically connected to the second cathode, and wherein the first anode and the second anode are electrically connected to the first power module respectively;
a first microprocessor connected to the first information exchanger;
a first wireless transceiver connected to the first microprocessor;
a first battery management system connected to the first microprocessor and the plurality of first rechargeable batteries respectively;
a second device comprising a second connector, wherein the second connector is configured to engage with the first connector, and wherein the second connector further comprises:
a second power module electrically connected with the first power module; and
a second information exchanger connected with the first information exchanger;
a plurality of second rechargeable batteries electrically connected to the second power module;
a second microprocessor configured in the second device, wherein the second microprocessor is connected with the second information exchanger;
a second battery management system connected with the second microprocessor and the plurality of second rechargeable batteries respectively; and
a second wireless transceiver connected with the second microprocessor, wherein the second wireless transceiver is configured to communicate with the first wireless transceiver.

2. The portable apparatus having detachable wireless elements as claimed in claim 1, wherein the first connector is a male connector or a female connector.

3. The portable apparatus having detachable wireless elements as claimed in claim 2, wherein the second connector is a male connector or a female connector, and wherein the second connector is paired with the first connector.

4. The portable apparatus having detachable wireless elements as claimed in claim 1, wherein the first device further comprises an acoustic pattern recorder connected with the first microprocessor, and wherein the second device further comprises an acoustic pattern recognition module connected with the second microprocessor.

5. The portable apparatus having detachable wireless elements as claimed in claim 1, wherein the first device further comprises a fingerprint recorder connected with the first microprocessor, and wherein the second device further comprises a fingerprint recognition module connected with the second microprocessor.

6. The portable apparatus having detachable wireless elements as claimed in claim 1, wherein the first device further comprises a pressure sensor connected with the first microprocessor.

7. The portable apparatus having detachable wireless elements as claimed in claim 1, wherein the second device further comprises a memory module connected with the second microprocessor.

8. The portable apparatus having detachable wireless elements as claimed in claim 1, wherein the second device further comprises an image sensor connected with the second microprocessor.

9. The portable apparatus having detachable wireless elements as claimed in claim 1, wherein the first wireless transceiver and the second wireless transceiver each is an NFC transceiver, an WiFi transceiver, a Bluetooth transceiver, a 4G-LTE transceiver, or an RFID transceiver.

10. The portable apparatus having detachable wireless elements as claimed in claim 1, wherein the first device is a tablet, a smartphone, or a PDA, and wherein the first device is accessible by a mobile telecommunications network or internet.

11. The portable apparatus having detachable wireless elements as claimed in claim 1, wherein the second device is a wireless headset, and wherein the wireless headset is accessible by a wireless network.

12. The portable apparatus having detachable wireless elements as claimed in claim 11, wherein the wireless network is a Bluetooth network, a WiFi network, or an infrared network.

13. The portable apparatus having detachable wireless elements as claimed in claim 1, wherein the first device further comprises a dock, and wherein the dock is configured to accommodate the second device.
